(19) United States
(12) Patent Application Publication
(10) Pub. No.: US 2022/0107770 A1
(43) Pub. Date: Apr. 7, 2022

(54) CONTROL METHOD AND INFORMATION PROCESSING APPARATUS

(71) Applicant: CANON KABUSHIKI KAISHA, Tokyo (JP)

(72) Inventor: Tomoya Ishida, Kanagawa (JP)

(21) Appl. No.: 17/487,818

(22) Filed: Sep. 28, 2021

(30) Foreign Application Priority Data
Oct. 6, 2020 (JP) 2020-169200

(51) Int. Cl. G06F 3/12; G06F 3/0486

(52) U.S. Cl. CPC G06F 3/1253; G06F 3/1272; G06F 3/1208; G06F 3/0486

(57) ABSTRACT

A position in a second page spread corresponding to a position in which an object is placed in a first page spread is used as a paste candidate position, and whether the paste candidate position is in a placement possible area is determined. In a case where the paste candidate position is determined as being in the placement possible area, the object is pasted in the paste candidate position, and in a case where the paste candidate position is determined as not being in the placement possible area, the object is pasted in a position different from the paste candidate position in the second page spread.

### BACKGROUND

### Field of the Disclosure

The present disclosure relates to a control method and an information processing apparatus. The present disclosure particularly relates to a technique for pasting an object.

### Description of the Related Art

There is photo album creation software for creating a photo album from data of pictures accumulated by a user. The photo album creation software has an editing function of editing a laid out image and an editing function of inputting a character or a stamp (see Japanese Patent Application Laid-Open No. 2018-19330).

### SUMMARY

According to an aspect of the present disclosure, a control method executed by at least one processor in an information processing apparatus includes storing an object placed on a first page spread in a memory area of the information processing apparatus based on a copy operation by a user, performing paste processing for pasting the stored object on a second page spread different from the first page spread, and performing determination processing for determining whether a paste candidate position of the object is in a placement possible area, wherein, in the determination processing, a position in the second page spread corresponding to a position in which the object is placed in the first page spread is used as a paste candidate position, and whether the paste candidate position is in the placement possible area is determined, and wherein, in the paste processing, in a case where the paste candidate position is determined as being in the placement possible area, the object is pasted in the paste candidate position, and in a case where the paste candidate position is determined as not being in the placement possible area, the object is pasted in a position different from the paste candidate position in the second page spread.

Further features of the present disclosure will become apparent from the following description of exemplary embodiments with reference to the attached drawings.

### BRIEF DESCRIPTION OF THE DRAWINGS

FIG. 1 is a diagram illustrating a configuration of a system including an information processing apparatus.

FIG. 2 is a diagram illustrating a hardware configuration of a personal computer (PC).

FIG. 3 is a diagram illustrating a software configuration of the PC.

FIG. 4 is a schematic diagram illustrating covers of an album.

FIGS. 5A and 5B are diagrams illustrating screens of an application.

FIGS. 6A and 6B are diagrams illustrating screens of the application.

FIG. 7 is a diagram illustrating a screen of the application.

FIG. 8 is a flowchart according to a first exemplary embodiment.

FIGS. 9A, 9B, 9C and 9D are diagrams illustrating an example of processing from inputting to pasting a text.

FIGS. 10A and 10B are diagrams illustrating an example of pasting.

FIGS. 11A and 11B are diagrams illustrating an example of pasting.

FIGS. 12A and 12B are diagrams illustrating an example of pasting.

FIGS. 13A and 13B are diagrams illustrating an example of pasting.

FIG. 14 is a flowchart according to a second exemplary embodiment.

FIGS. 15A, 15B and 15C are diagrams each illustrating a relationship between an object and an instruction position.

FIGS. 16A and 16B are diagrams illustrating an example of pasting.

FIGS. 17A, 17B and 17C are diagrams illustrating an example of pasting.

FIGS. 18A and 18B are diagrams illustrating an example of pasting.

FIGS. 19A and 19B are diagrams illustrating an example of pasting.

### DESCRIPTION OF THE EMBODIMENTS

When an object such as a character is input to a photo album, a case is considered in which the object is placed on a page spread in the photo album, and then the placed object is copied and pasted on another page spread thereof. However, in the photo album, some page spreads may include an area in which the object cannot be placed. According to Japanese Patent Application Laid-Open No. 2018-19330, a method for performing control to prevent an object from being placed in a binding portion is discussed, but a method for copying and pasting the object and a copy and paste operation across pages are not discussed. The present disclosure is directed to performing appropriate control on a paste position.

Exemplary embodiments of the present disclosure will be described in detail below with reference to the attached drawings. The exemplary embodiments described below are not intended to limit the present disclosure set forth in the claims, and not all combinations of features described in the exemplary embodiments are always essential to the solving means of the present disclosure.

### <System Configuration>

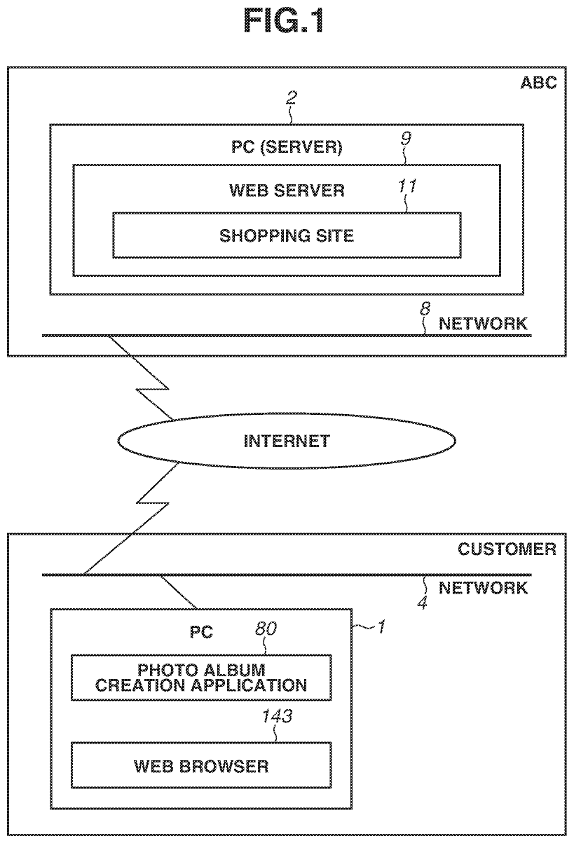

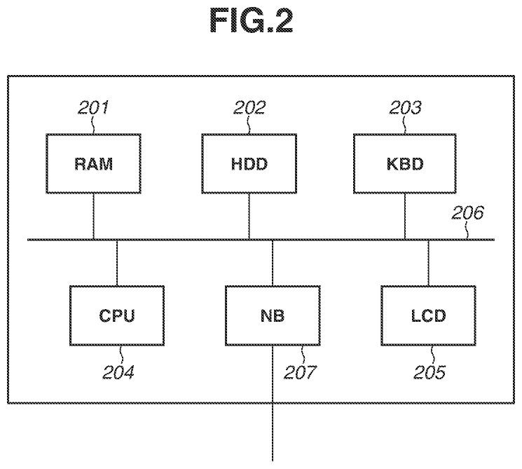

FIG. 1 illustrates an example of a configuration of a photo album creation/ordering system. In FIG. 1, an information processing apparatus that is a personal computer (PC) 1 is a commonly used personal computer, and an information processing apparatus that is a PC 2 is a server. The PCs 1 and 2 arc constituted of hardware components as described below with reference to FIG. 2, and Windows® or the like is installed thereon as an operating system (hereinafter, sometimes abbreviated as OS). The PCs 1 and 2 are respectively connected to networks 4 and 8 constituted of Ethernet®.

A photo album creation application 80 is installed on the PC 1. The photo album creation application 80 includes, for example, a file of Windows® executable format (*.exe). A web browser application 143 (hereinafter, sometimes referred to as a web browser) is a browser used in using a world wide web (WWW). The network 4 is a local network and is, for example, a home network constructed at home where a user (a customer) who uses the PC 1 lives. The network 8 is an office network constructed in a workplace of a company (for example, ABC Company) which provides a photo book creation service.

The PC 2 connected to the network 8 includes a web server 9 having a web server function and provides a web site of ABC Company via the Internet. A shopping site 11 is a shopping site provided by ABC Company to users, and a user can order a photo album using the shopping site 11. When the photo album is ordered, printing and bookbinding are performed based on photo album data transmitted to the PC 2 that is the server, and a completed photo album booklet is delivered to the user.

### <Hardware Configuration>

FIG. 2 illustrates an example of a hardware configuration of the PC. The PCs 1 and 2 each include hardware components illustrated in FIG. 2. As illustrated in FIG. 2, the PCs 1 and 2 each include a random access memory (RAM) 201 that is a random access memory unit, a hard disk drive (HDD) 202 that is a hard disk drive unit, a keyboard (KBD) 203 that is a keyboard unit, and a central processing unit (CPU) 204. Further, the PCs 1 and 2 each include a liquid crystal display (LCD) 205 that is a display, and a network board (NB) 207. Furthermore, the PCs 1 and 2 each include at least a bus 206 which connects the blocks illustrated in FIG. 2 to be communicable with each other. The HDD 202 is, for example, a storage unit of each of the PCs 1 and 2. The storage unit may be a portable compact disk read only memory (CD-ROM) or a built-in ROM. The KBD 203 is, for example, an input unit of each of the PCs 1 and 2.

The CPU 204 is, for example, a control unit of each of the PCs 1 and 2. The LCD 205 is, for example, a display unit of each of the PCs 1 and 2. The NB 207 is, for example, a communication control unit of each of the PCs 1 and 2.

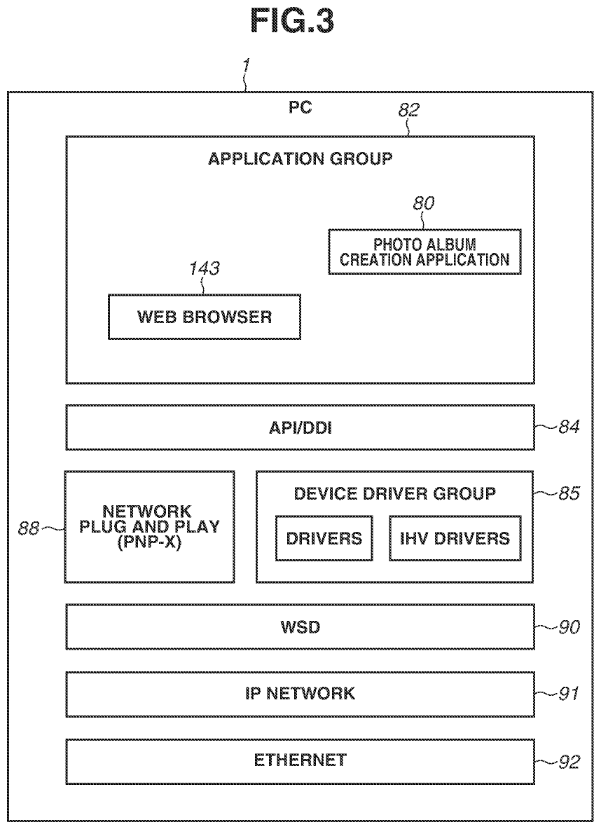

Application programs, such as the photo album creation application 80 and the web browser 143, and each module (software) illustrated in FIG. 3 are stored in, for example, the HDD 202, read into the RAM 201 as necessary, and executed by the CPU 204. Accordingly, the CPU 204 implements functions of the application programs, such as the photo album creation application 80 and the web browser 143, and each module (software) illustrated in FIG. 3.

### <Software Configuration>

FIG. 3 illustrates an example of a software module configuration of the PC. In FIG. 3, a module 92 is an Ethernet® control stack for controlling the Ethernet®. A module 91 is an internet protocol (IP) control stack for controlling the IP network. A module 90 is a Web Services on Devices (WSD) control stack for controlling WSD which provides a mechanism for searching for a device on the network. A module 88 is a plug and play extensions (PnP-X) control stack for controlling plug and play on the network. PnP-X is a function installed as standard on Windows® as a series of plug and play extension functions of providing support for a network connection device. A module 85 is a device driver group which includes a standard driver group included in the OS as standard and an independent hardware vendor (IHV) driver group provided by an IHV.

A module 84 is an application interface/Device Driver Interface (DDI), and includes an application programming interface (API) and a DDI. A module 82 is an application group and includes the photo album creation application 80 and the web browser 143.

### <Editing Screen>

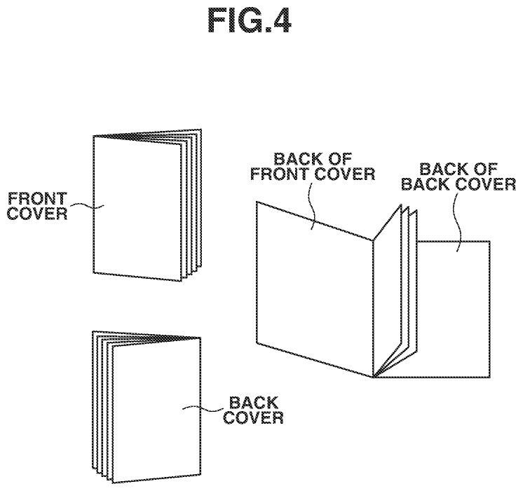

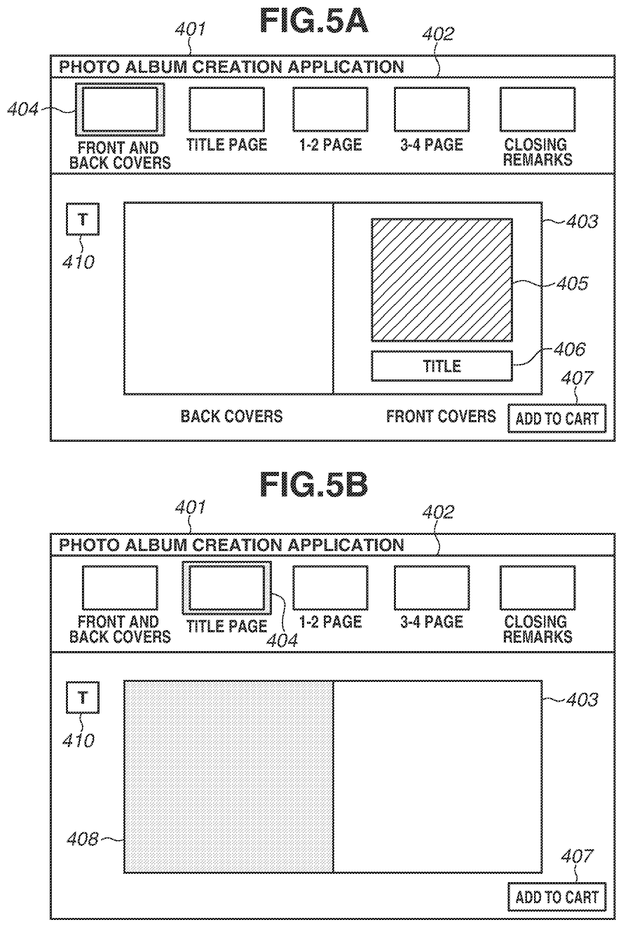

A relationship between an editing screen and a prohibited area is described with reference to FIGS. 4 to 7. FIG. 4 illustrates a photo album after bookbinding, and FIGS. 5A to 7 illustrate examples of editing screens provided by the photo album creation application 80 to create photo album data. The editing screens are displayed as a result of laying out an image such as a picture using the photo album creation application 80 (hereinafter, sometimes referred to as the application). As a method for laying out an image, a user may manually place the image, or the application may automatically place the image on a template based on a user instruction.

FIG. 5A illustrates the editing screen in a state in which a front cover and a back cover are displayed. As illustrated in FIG. 4, the front cover and the back cover are outer portions of the cover. An editing screen 401 is an area indicating a screen provided by the application and includes a thumbnail display area 402 of each page in the photo album and a display area 403 of the photo album. If a user selects a desired thumbnail from among thumbnails in the thumbnail display area 402, the thumbnail turns into a selected state 404. Then, a page represented by the thumbnail in the selected. state 404 is displayed in the display area 403 of the photo album, and an editing operation can be performed thereon. In FIG. 5A, a page spread of the front cover and the back cover is in the selected state.

A picture is assigned to each picture slot 405. A user can input a text in a text box 406, and a title of the photo album is input to the text box 406 on the front cover. A text addition button 410 is a button for placing an optional text box. The user can place a text in any location by issuing an instruction using the text addition button 410. A button 407 is used to put the edited photo album into a cart. If the user presses the button 407, the edited photo album is uploaded to the shopping cart via the Internet.

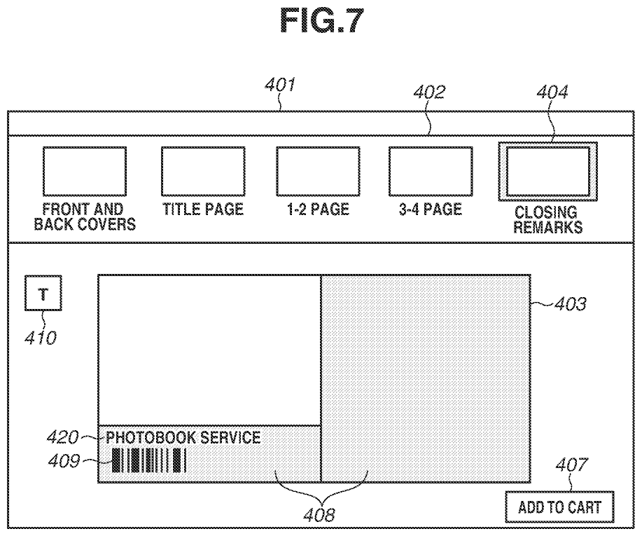

FIG. 5B illustrates the editing screen in a state in which a back page of the front cover and a page adjacent to the back page are displayed respectively on the left and the right. In FIG. 5B, a placement prohibited area 408 is provided on the back page of the front cover. The placement prohibited area 408 is an area in which an object such as a text box cannot be placed, A placement prohibited area is an area in which an object cannot be placed. The placement prohibited area is an area provided due to specifications of the photo album, and in the present exemplary embodiment, the placement prohibited area also exists in a page other than the back page of the front cover. Specifically, a back page of the back cover described below with reference to FIG. 7 and an area in which a barcode and a service name are provided are the placement prohibited areas. The placement prohibited area may be provided to one area, or may be provided in an area different from the back page of the front cover and the back page of the back cover. In addition, the placement prohibited area may be provided in a binding portion of the photo album. For example, in a bulging type binding method (hereinafter, referred to as a standard type) such as perfect binding, if a text overlaps with a folding line of a page in the photo album, a character on the folding line is difficult to see. As described above, if a character is placed near the folding line in the standard type, it is difficult to see the character, so that it may be desirable to place an object at some distance from the folding line. Thus, in the case of the standard type photo book, a binding portion area may be set as the placement prohibited area.

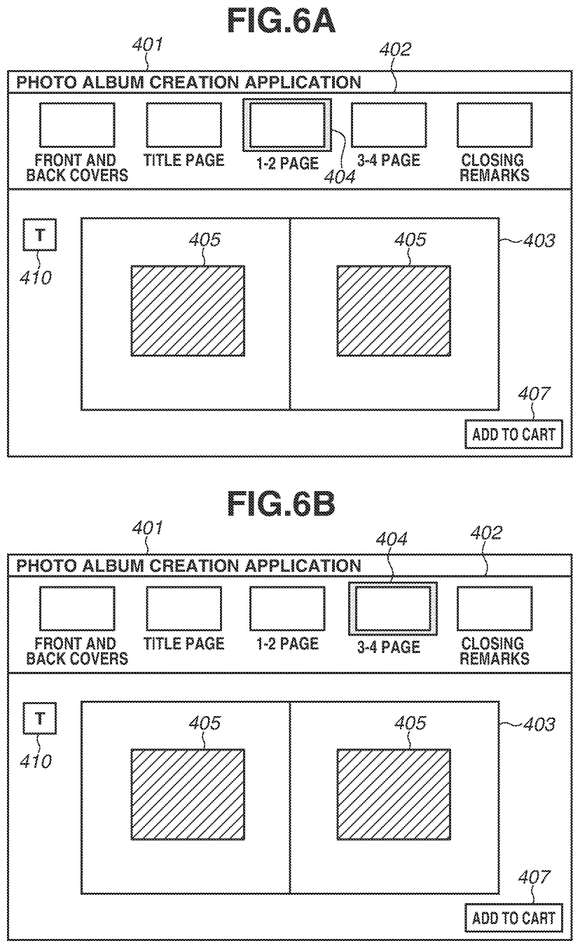

FIG. 6A illustrates the editing screen in a state in which a page spread of pages 1 and 2 is displayed. FIG. 6B illustrates the editing screen in a state in which a page spread of pages 3 and 4 is displayed. The pages illustrated in FIGS. 6A and 6B are also referred to as a text block, and in this example, the placement prohibited area 408 is not provided in the text block.

FIG. 7 illustrates the editing screen in a state in which the back page of the back cover and a page adjacent to the back page are displayed respectively on the left and the right. The back page of the back cover and the adjacent page are also collectively referred to as colophon pages. The placement prohibited area 408 is set to the back page of the back cover of the colophon pages. A bar code 409 and a service name 420 are provided in a lower portion of the adjacent page. In a case where the bar code 409 and the service name 420 are provided, they will be difficult to be read, for example, if a text box is placed thereon. Thus, an area of the bar code 409 and the service name 420 is also set as the placement prohibited area 408 in this example.

### <Control Method of Photo Album Creation Application>

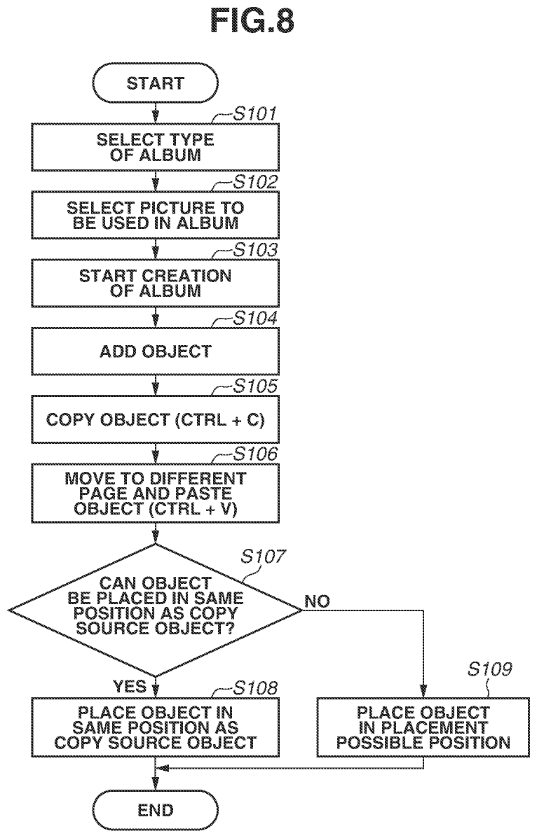

FIG. 8 is a flowchart illustrating processing executed by the photo album creation application 80. The processing in the flowchart illustrated in Fig, 8 is implemented by, for example, the CPU 204 loading a program stored in the HDD 202 to the RAM 201 and executing the program.

In step S101, the CPU 204 selects a type of the photo album to be created based on a user instruction. For example, the type of photo album refers to a size, the number of pages, a binding method, a type of paper, and the like of the photo album.

In step S102, the CPU 204 selects a picture to be used in the photo album based on the user instruction. For example, in a case where a picture is stored in a picture folder of the PC 1, the user selects the picture folder, and. thus a picture group is selected.

In step S103, the CPU 204 starts to create the photo album data based on the user instruction. For example, the CPU 204 which has read the photo album creation application 80 generates a template for automatically placing the picture and automatically places the picture in a slot in the template based on the type of the photo album selected in step S101 and the picture selected in step S102. Once the template and a layout of the picture are determined, first, the editing screen illustrated in FIG. 5A is displayed. The user manually starts a correction (editing) operation using the editing screen while referring to a layout result.

The processing for automatically placing the picture based on the user instruction has been described here. However, the present exemplary embodiment is not limited to this processing. For example, the user may manually determine the template and the picture to be used in the photo album and manually place the picture in the template.

In step S104, the CPU 204 adds an object based on the user instruction. The present flowchart is based on the premise that the user adds an object and copies and pastes the object to a different page, so that the processing in steps S104 to S109 is performed. However, in a case where the object is not added or copied and pasted, the processing in steps S104 to S109 may be omitted, and editing processing may be completed in response to pressing of the button 407. In the present example, in step S104, the user selects the text addition button 410, and thus the CPU 204 adds the text box 406 as the object.

In step S105, the CPU 204 copies the object added in step S104 based on a copy operation such as “Ctrl+C” by the user. In this step, the text box 406 is stored in a memory area (for example, the RAM 201) of the PC 1 based on the copy operation by the user.

In step S106, the CPU 204 pastes the object copied in step S105 on a different page by a paste operation such as “Ctrl+V”. In this step, the stored text box 406 is pasted on the different page based on the paste operation by the user.

In step S107, the CPU 201 executes determination processing for determining whether the object can be placed in a position (typically the same position) corresponding to a placement position of a copy source object. In the present exemplary embodiment, it is assumed that a paste candidate position is basically set to a position corresponding to the placement position of the copy source object. Specifically, a coordinate position (coordinates in the page) of the copy source object and a coordinate position (coordinates in the page) of the paste candidate position are set to be the same. For example, a case in which a user performs a copy and paste operation to insert a page number to an album and a case in which a user performs a copy and paste operation to input information about the month of imaging of each page in an album are considered. In such cases, the user may want to place the object in the same position in the page. Thus, in the present example, in the case where the object is copied and pasted on the different page, the paste candidate position is set to the position corresponding to the position of the copy source object by default.

As a method for determining whether the object can be placed in the position corresponding to the placement position of the copy source object in step S107, specifically, the CPU 204 determines whether the paste candidate position (the position corresponding to the coordinate position of the copy source object) is not in the placement prohibited area.

In step S107, in a case where it is determined that the object can be placed (YES in step S107), then in step S108, the CPU 204 places the object in the position corresponding to the position of the copy source object (typically the same coordinate position). On the other hand, in step S107, in a case where it is determined that the object cannot be placed (NO in step S107), then in step S109, the CPU 204 places the object in a placement possible position (in a placement possible area). The placement possible position is a position in an area other than the placement prohibited area.

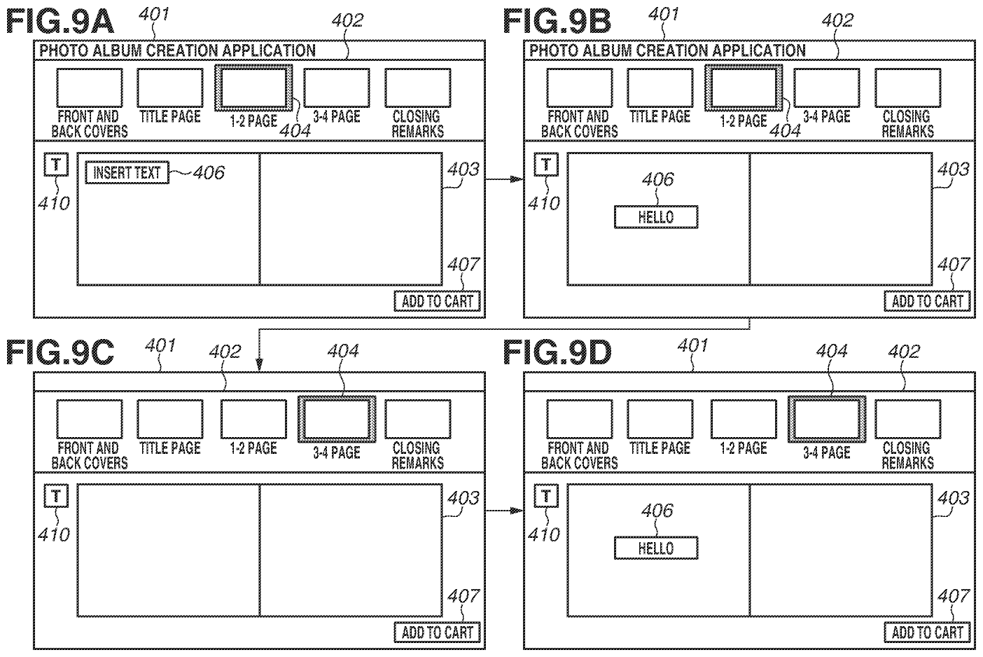

Specific paste control is described below with reference to FIGS. 9A to 13B. First, a basic example in which the text box 406 is inserted and then is copied and pasted on a different page is described with reference to FIGS. 9A, 9B, 9C, and 9D.

FIG. 9A illustrates a state in which the user selects the text addition button 410, and thus the text box 406 is placed in a default insertion position in the page spread of pages 1 and 2. In the present example, the default insertion position in which the text box 406 is placed at the time of being newly inserted is set to an upper left position.

FIG. 9B illustrates a state in which the user inputs a text (here, “Hello”) in the text box 406 and moves the text box 406 to a position (here, the center of the same page). In this state, the text box 406 is copied by the copy operation (for example, a keyboard operation of Ctrl+C) by the user and stored in the memory area of the PC 1.

FIG. 9C illustrates a state in which the user selects the thumbnail of the page spread of pages 3 and 4, and thus the page spread of pages 3 and 4 is displayed in the display area 403 of the photo album. In other words, FIG. 9C illustrates a state in which the display is switched to another page spread.

FIG. 9D illustrates a state in which the text box 406 is pasted on the page spread of pages 3 and 4 by the paste operation (for example, the keyboard operation of Ctrl+V) by the user. In this case, since the placement prohibited area is not set to the pages 3 and 4 and the text box 406 can be placed in the paste candidate position (the center of the page), the text box 406 is placed in the paste candidate position.

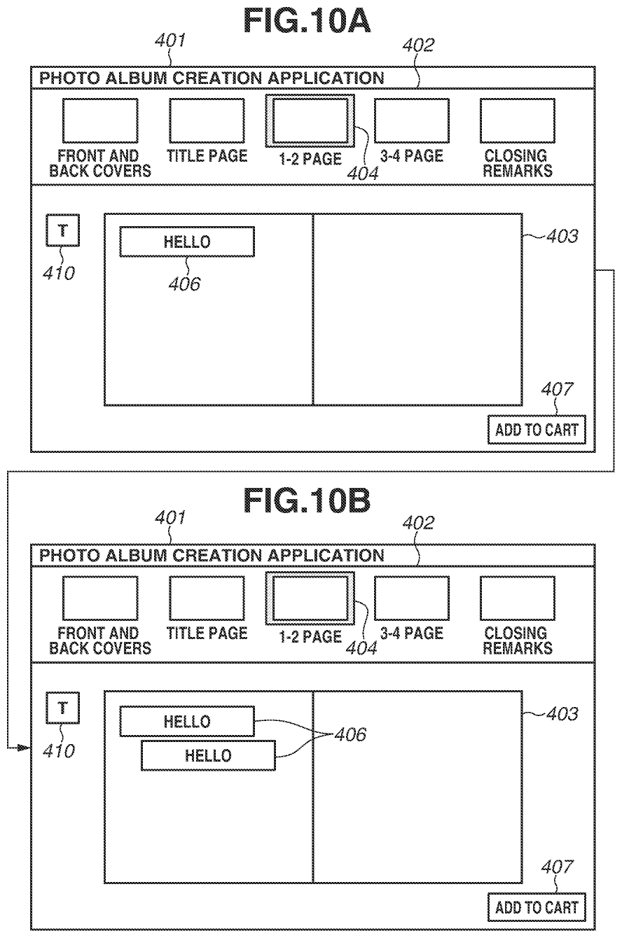

The case in which the object is pasted on the different page has been described in FIGS. 9A to 9D. However, in the present exemplary embodiment, the object can be pasted on the same page. An example of copying and pasting the text box 406, which is the object, on the same page is described with reference to FIGS. 10A and 10B. FIG. 10A illustrates a state in which the page spread of pages 1 and 2 is displayed. The user copies the text box 406 in this state. FIG. 10B illustrates a case in which the user performs the paste operation, such as Ctrl+V, on the page spread of pages 1 and 2. As illustrated in FIG. 10B, the text box 406 is pasted in a position slightly shifted to lower right from the text box 406 that is the copy source object in the present example. In the case of the present example, a default position of the paste candidate position is set to the lower right of the copy source object in the copy and paste operation on the same page. Since the pages 1 and 2 do not include the placement prohibited area, the object can be pasted in the paste candidate position in FIG. 10B. However, in a case where the paste candidate position is in the placement prohibited area, the object is pasted in a position in the area different from the placement prohibited area. As described above, in the present exemplary embodiment, the default paste candidate position is different depending on whether the object is pasted on the different page as illustrated in FIGS. 9A, 9B, 9C, and 9D or on the same page as illustrated in FIGS. 10A and 10B. In other words, in the case of the different page, the default paste candidate position is set to the position corresponding to the placement position of the copy source object, and in the case of the same page, the default paste candidate position is set to a vicinity of the placement position of the copy source object.

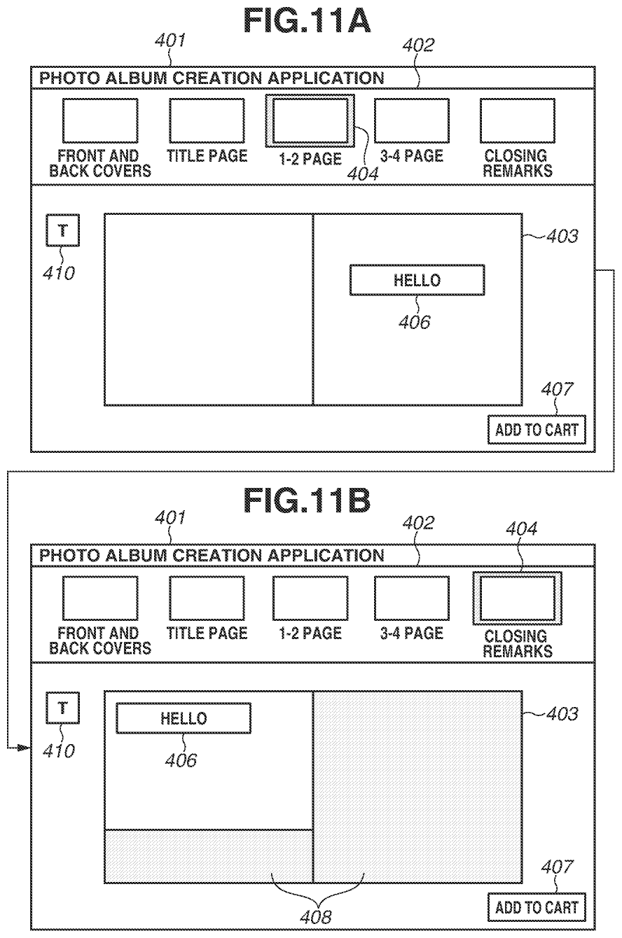

Next, an example in which the placement prohibited area 408 is set to the paste candidate position in the case where the object is pasted on the different page is described with reference to FIGS. 11A to 13B.

FIGS. 11A and 11B illustrate an example in a case where the text box 406 placed on a page in the text block is copied and pasted on the colophon page. FIG. 11A illustrates a state in which the page spread of pages 1 and 2 is displayed, and the user copies the text box 406 in this state. FIG. 11B illustrates a state in which the back page of the back cover and the adjacent page thereto, which are the colophon pages, are displayed. The user pastes the previously copied text box 406 by the operation of Ctrl+V in this state. In this case, the same position as that of the copy source object which is the paste candidate position is in the placement prohibited area 408, and thus the object cannot be pasted therein. Thus, the object is placed in a placement possible area in the same page spread. In the present example, the text box 406 is placed in an upper left position in a left page of the page spread. The upper left position is the same position as the position in which the text box 406 is newly inserted in a case where an instruction is issued using the text addition button 410 in FIGS. 9A to 9D. Accordingly, the object is placed in a position easily recognizable by the user as much as possible.

In the example in FIGS. 11A and 11B, the case has been described in which the paste candidate position of the text box 406 is completely included in the placement prohibited area 408. However, the present exemplary embodiment is not limited to this case. More specifically, also in a case where part of the paste candidate position overlaps with the placement prohibited area 408, the object may be placed in an area different from the placement prohibited area 408 as illustrated in FIGS. 11A and 11B. In other words, a paste destination may be determined so that not even part of the paste candidate position overlaps with the placement prohibited area 408.

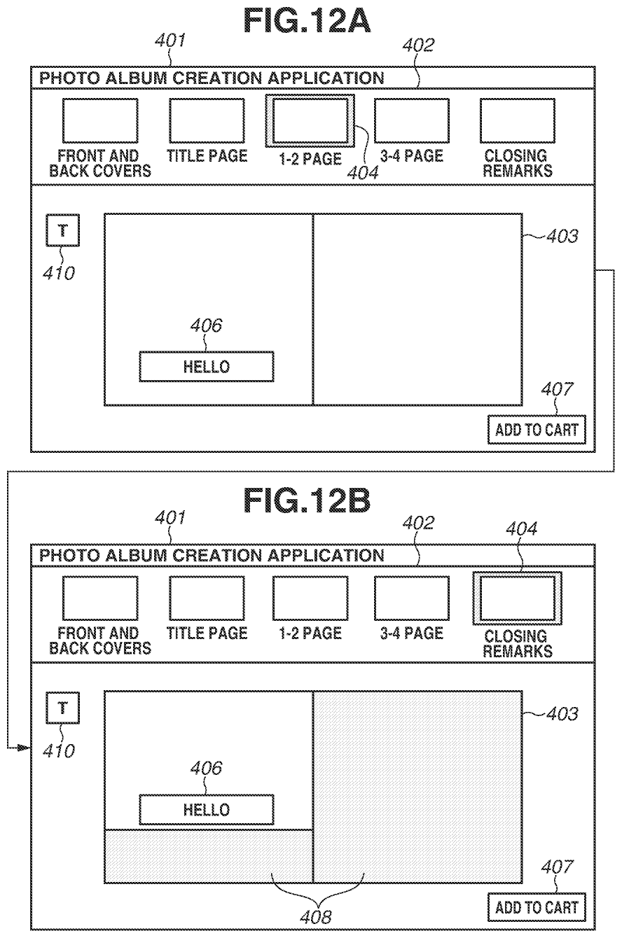

FIGS. 12A and 12B illustrate another example in which the text box 406 placed on a page in the text block is copied and pasted on the colophon page. FIG. 12A illustrates a state in which the page spread of pages 1 and 2 is displayed, and the user copies the text box 406 in this state. FIG. 12B illustrates a state in which the back page of the back cover and the adjacent page thereto, which are the colophon pages, are displayed. The user pastes the previously copied text box 406 by the operation of Ctrl+V in this state. In this case, the same position as that of the copy source object which is the paste candidate position overlaps with the placement prohibited area 408, and thus the object cannot be placed therein. Thus, the object is placed in the placement possible area in the same page spread. In the present example, the text box 406 is placed above the placement prohibited area 408 on the left page of the page spread. The position has the same coordinate on a horizontal axis as the position in which the text box 406 is placed in FIG. 12A. Accordingly, the object is placed in a position that is as close as possible to a user's intended position.

In the example in FIGS. 12A. and 12B, the present exemplary embodiment is not limited to the ease in which the paste candidate position of the text box 406 is completely included in the placement prohibited area 408.

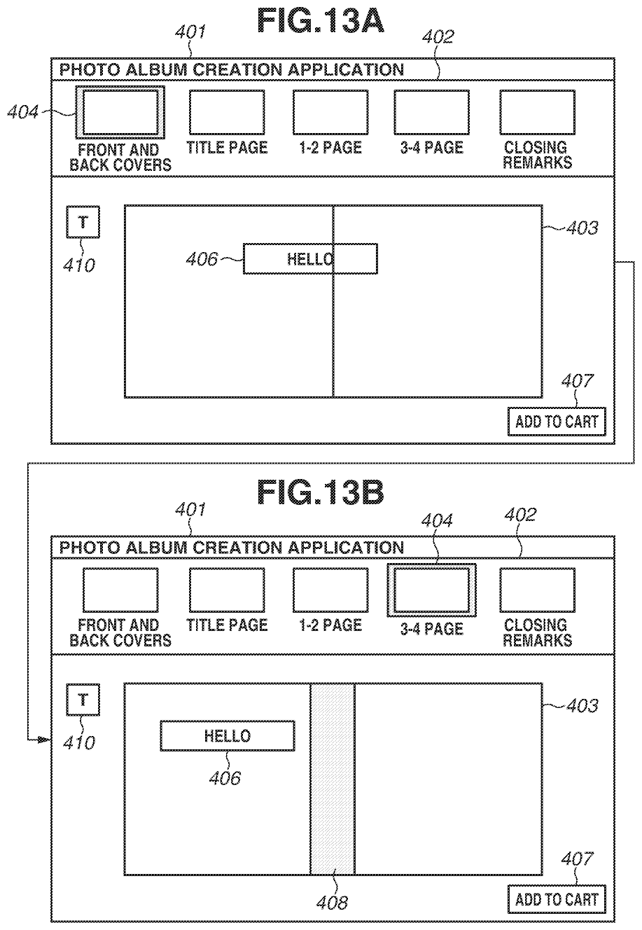

FIGS. 13A and 13B illustrate another example in which the text box 406 placed on a cover page is copied and pasted on a page spread in the text block. FIG. 13A illustrates a state in which the cover page is displayed. The user copies the text box 406 placed at the center of a page spread of the cover page. FIG. 13B illustrates a state in which the page spread (the pages 3 and 4) in the text block is displayed. The user pastes the previously copied text box 406 by the operation of Ctrl+V in this state. In this case, the same position as that of the copy source object which is the paste candidate position partially overlaps with the placement prohibited area 408, and thus the object cannot be pasted therein. In the present example, the text box 406 is placed in an upper part of a left page of the page spread. The position has the same coordinate on a vertical axis as the position in which the text box 406 is placed in FIG. 13A. Accordingly, the object is placed in a position that is as close as possible to the user's intended position.

In the present exemplary embodiment, in the case where part of the paste candidate position overlaps with the placement prohibited area 408, the object is pasted in a position in the area different from the placement prohibited area 408 as described above with reference to FIGS. 11A, 11B, 12A, 125, 13A, and 13B. As the position in the area different from the placement prohibited area, the default position in a case where the text box is newly added and the position near the position of the copy source object are described as examples. However, the present exemplary embodiment is not limited to the examples. The text box may be placed in any position in an area in which the text box can be placed.

While the text box 406 has been described as an example of the object, the present exemplary embodiment is not limited to the text box. The object may be any object which can be copied and pasted such as an image such as a picture and a stamp 412.

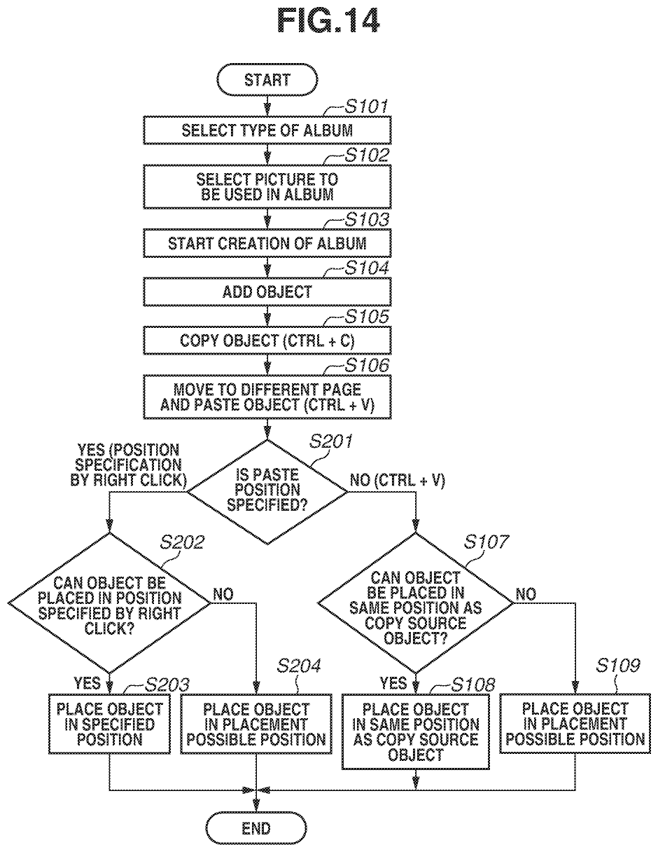

Next, a second exemplary embodiment is described with reference to FIGS. 14 to 16B. In the second exemplary embodiment, an example is described in which a user specifies a paste position of an object such as a text box 406, a picture 411, or a stamp 412 and pastes the object. As a method for specifying the paste position by the user, there may be a method for specifying a position by clicking a right mouse button (hereinafter, also referred to as right-click) and selecting pasting from a menu displayed by the right-click. However, the method is not limited to the above-described one, and, for example, an object may be pasted by an operation of Ctrl+V in a state in which the position is specified by clicking a left mouse button.

FIG. 14 is a flowchart illustrating processing executed by the photo album creation application 80. The processing in the flowchart illustrated. in FIG. 14 is implemented by, for example, the CPU 204 loading a program stored in the HDD 202 to the RAM 201 and executing the program.

In FIG. 14, the processing in steps S101 to S106 is basically similar to that in steps S101 to S106 described with reference to FIG. 8, and thus the description of the similar processing is omitted. However, a pasting method in step S106 may be different, and subsequent processing is different depending on the pasting method.

In the present exemplary embodiment, in step S106, the CPU 204 performs processing for pasting the object copied in step S105 on a different page. At this time, a method for pasting the object based on the paste position specified by the user and a method for simply pasting the object by an operation of Ctrl+V as in the first exemplary embodiment (a method in which only a page is specified and a position is not specified) are considered.

Thus, in step S201, the CPU 204 determines whether the paste position is specified. Specifically, in a case where the user specifies the position by right-clicking the mouse and selects pasting from the menu displayed by the right-click, it is determined as YES in step S201. On the other hand, in a case where the user instructs pasting simply by the operation of Ctrl+V in a state in which the different pages are displayed as in the first exemplary embodiment, it is determined as NO in step S201. In the case where it is determined as YES in step S201, the processing proceeds to step S202, whereas, in the case where it is determined as NO in step S201, the processing proceeds to step S107. The processing in steps S107 to S109 is similar to that in steps S107 to S109 described with reference to FIG. 8, and thus the description thereof is omitted.

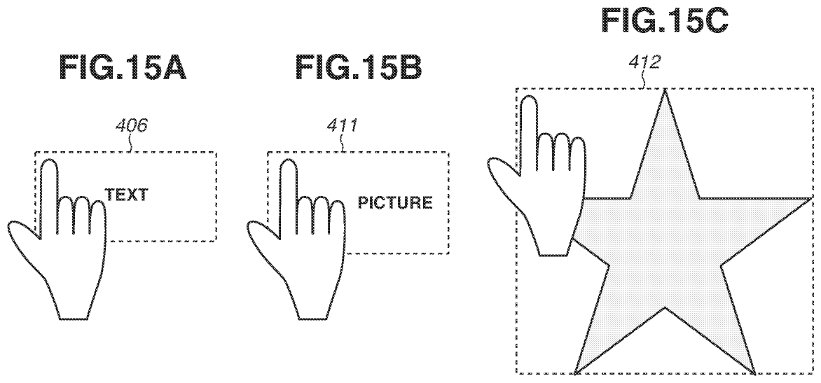

A relationship between the paste position specified by the user and the object is described with reference to FIGS. 15A, 15B, and 15C. FIGS. 15A, 15B, and 15C respectively illustrate examples of pasting the text box 406, the picture 411, and the stamp 412. Pointing finger marks in FIGS. 15A, 15B, and 15C represent cursors. Thus, a mark such as an arrow may be used. In this example, if the user right-clicks at a certain position, the object is pasted so that the right-clicked position (a position of an index finger corresponding to the cursor) coincides with an upper left corner of a rectangle of the object. For example, in the case of the stamp 412, the stamp 412 is pasted so that the right-clicked position coincides with an upper left corner of a rectangle surrounding the stamp 412. In the following descriptions, an example is described in which the object is pasted so that the right-clicked position coincides with the upper left corner of the rectangle of the object. However, the present exemplary embodiment is not limited to this example. The object may be pasted so that a cursor position coincides with the center or the lower right corner of the rectangle of the object.

Referring back to FIG. 14, the description of the flowchart is continued. In step S202, the CPU 204 determines whether the object can be pasted in the paste position specified by the user. For example, the CPU 204 determines whether the object can be pasted in the right-clicked position. The determination in step S202 may be performed based on whether the paste position specified. by the user which is the paste candidate position according to the present exemplary embodiment overlaps with the placement prohibited area. However, in addition to the placement prohibited area, the determination may be performed based on whether the object protrudes from the page.

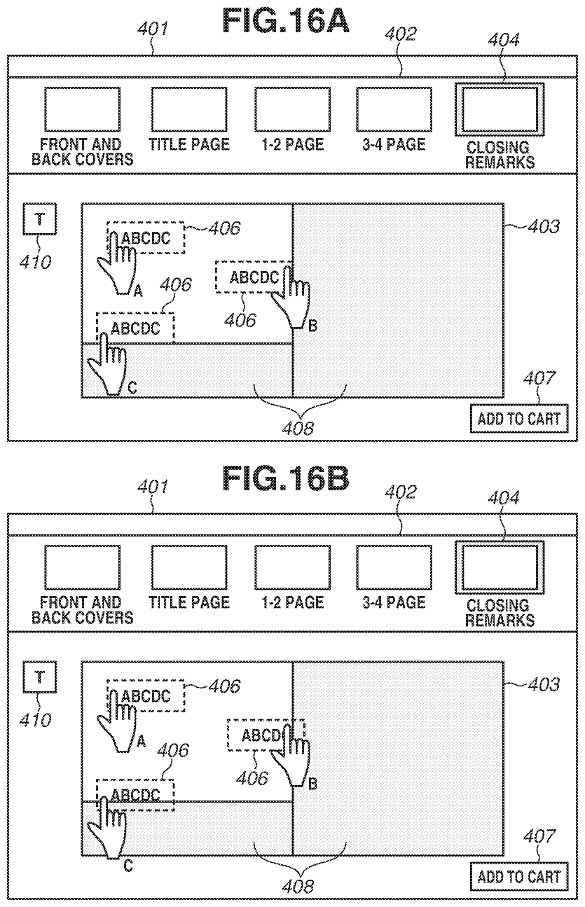

In step S203, the CPU 204 pastes the object (for example, the text box) in the paste position specified by the user (the paste candidate position). On the other hand, in step S204, since the object cannot be pasted in the paste position specified by the user (the paste candidate position), the CPU 204 pastes the object in the placement possible position. The processing is described. in detail below with reference to FIGS. 16A to 19B.

FIGS. 16A and 16B illustrate an example in which the user specifies the paste position by right-click on a page spread including the placement prohibited area 408 such as the colophon page. An object copy source is, for example, a page spread in the text block.

First, in a case where the user instructs pasting by right-clicking at a right-click position A in FIG. 16A, the text box 406 is not in the placement prohibited area and thus is pasted in the specified position. On the other hand, in a case where the user instructs pasting by right-clicking at a right-click position B in FIG. 16A, if the text box 406 is pasted in that position, part of the text box 406 overlaps with the placement prohibited area 408. Thus, in this case, the text box 406 is pasted so as not to overlap with the placement prohibited area 408 by the paste position thereof being shifted to the left as illustrated in FIG. 16A. Similarly, in a case where the user instructs pasting by right-clicking at a right-click position C in FIG. 16A, if the text box 406 is pasted in that position, part of the text box 406 overlaps with the placement prohibited area 408. Thus, in this case, the text box 406 is pasted so as not to overlap with the placement prohibited area 408 by the paste position thereof being shifted upward. As described above, the text box 406 is pasted in a position which does not overlap with the placement prohibited area 408, and thus it is possible to prevent characters from being cut off. Further, even in the case where the paste position is shifted, the object is pasted so that the paste position is in the same position on the vertical axis or the horizontal axis as that of the paste position specified by the user. Thus, the object can be placed in a position that is as close as possible to the user's intended position.

Instead of controlling the text box 406 not to overlap with the placement prohibited area 408, as illustrated in FIG. 16B, control may be performed based on a text in the text box 406 so that the text does not overlap with the placement prohibited area 408.

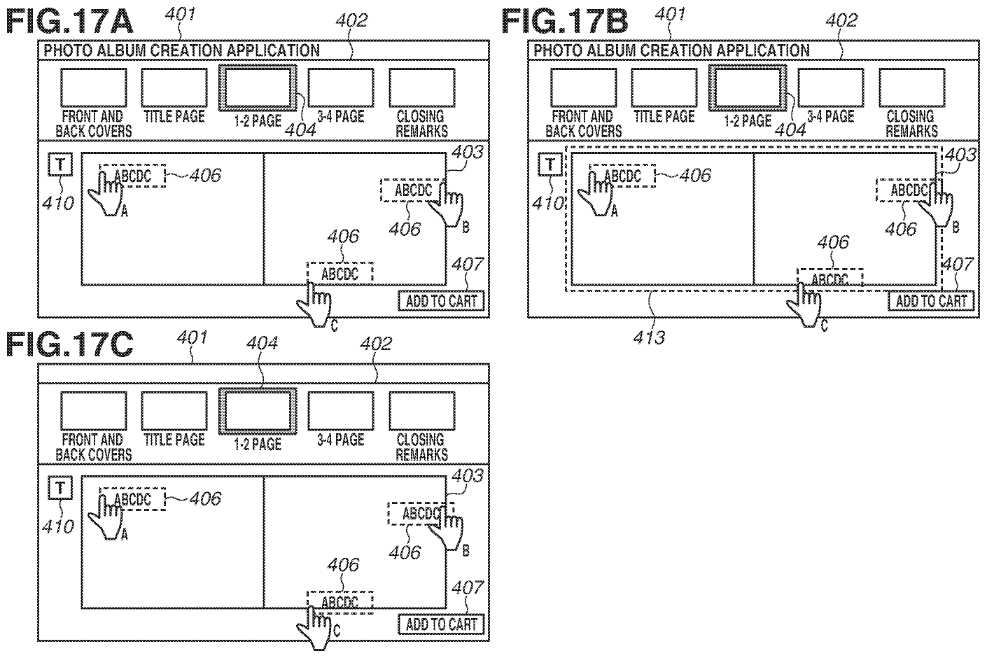

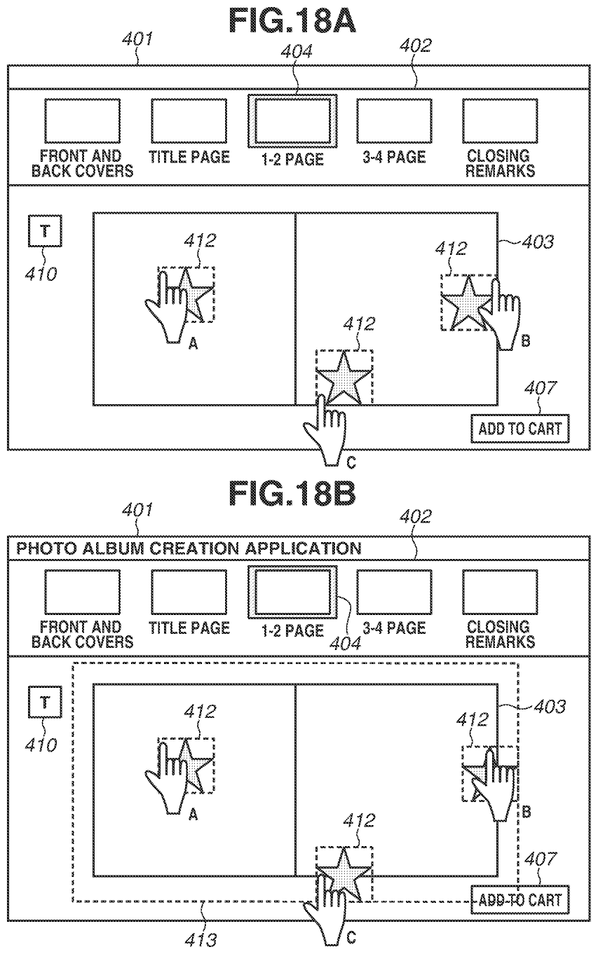

In the present exemplary embodiment, the object may also be controlled not to protrude from a page in addition to not to overlap with the placement prohibited area. An example is described with reference to FIGS. 17A, 17B, 17C, 18A, and 18B.

FIGS. 17A, 17B, and 17C illustrate an example in which the paste position of the text box 406 is specified by right-clicking, and the text box 406 is pasted. In a case where the user instructs pasting by right-clicking at the right-click position A in FIG. 17A, since the right-click position A is not in the placement prohibited area and the text box 406 does not protrude from the page, the text box 406 is pasted in that position. On the other hand, in a case where the user instructs pasting by right-clicking at the right-click position B in FIG. 17A, if the text box 406 is pasted in that position, the text box 406 protrudes from the display area 403 corresponding to the page of the photo album. Thus, in this case, the text box 406 is pasted so as not to protrude from the page by the paste position thereof being shifted to the left. Similarly, in a case where the user instructs pasting by right-clicking at the right-click position C in FIG. 17A, if the text box 406 is pasted in that position, the text box 406 protrudes from the display area 403 corresponding to the page of the photo album. Thus, in this case, the text box 406 is pasted so as not to protrude from the page by the paste position thereof being shifted upward. The control is performed as described above, and thus it is possible to prevent the text box 406 from protruding from a page of the photo album and characters from being cut off.

The editing screen 401 may be provided. with a movable area 413 in which the object can be moved. The object can often be moved in the album by a drag and drop operation, and in that case, the movable area 413 is determined as the area in which the object can be moved. In the present exemplary embodiment, the paste position may be controlled based on the movable area 413. In FIG. 17B, the object can be freely moved within the object movable area 413. In a case where the user instructs pasting by right-clicking at the right-click position A in FIG. 17B, the text box 406 can be pasted in the position and thus is pasted in the position. On the other hand, in a case where the user instructs pasting by right-clicking at the right-click position B in FIG. 17B, if the text box 406 is pasted in that position, the text box 406 protrudes from the display area 403 corresponding to the page of the photo album. Thus, in this case, the text box 406 is placed in the paste position shifted to the left and along the movable area 413. Further, in a case where the user instructs pasting by right-clicking at the right-click position C in FIG. 17B, if the text box 406 is pasted in that position, the text box 406 protrudes from the display area 403 corresponding to the page of the photo album. Thus, in this case, the text box 406 is placed in the paste position shifted upward and along the movable area 413.

Further, as illustrated in FIG. 17C, a text may be used as a reference instead of using a text box as a reference. In other words, the text may be placed so as not to protrude from the display area 403 corresponding to the page of the photo album.

Next, an example in which the paste position of the stamp 412 is specified by right-clicking and the stamp 412 is pasted is described with reference to FIGS. 18A and 18B. FIG. 18A illustrates an example in which the stamp 412 is placed to be included in the display area 403 corresponding to the page of the photo album, and control is similar to that in FIG. 17A. FIG. 18B illustrates an example in which the stamp 412 is placed to be along the movable area 413, and control is similar to that in FIG. 17B.

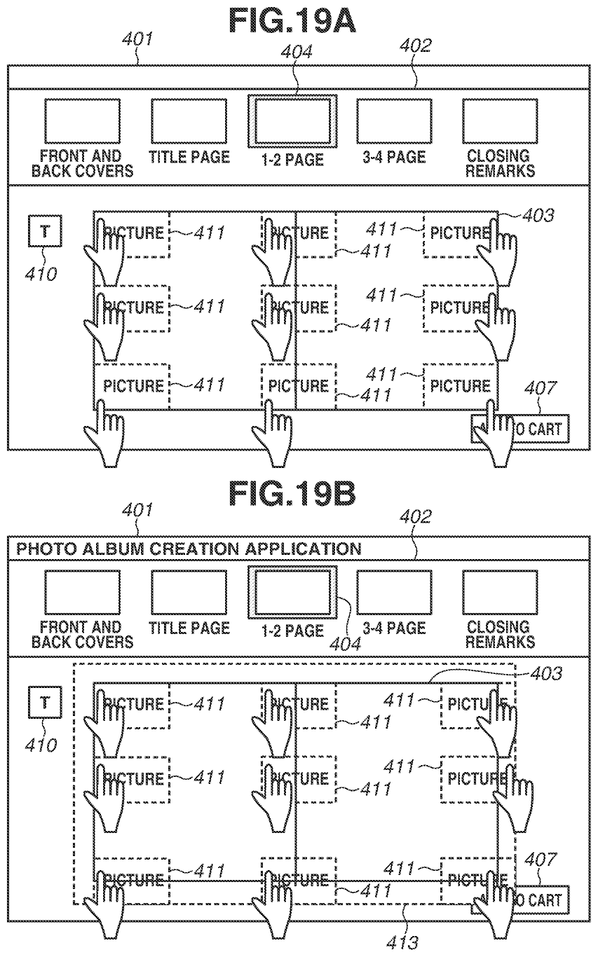

Next, an example in which the paste position of the picture 411 is specified by right-clicking and the picture 411 is pasted is described with reference to FIGS. 19A and 19B. FIG. 19A illustrates an example in which pictures 411 are placed to be included in the display area 403 corresponding to the page of the photo album, and control is similar to that in FIG. 17A. FIG. 19B illustrates an example in which the pictures 411 are placed to be along the movable area 413, and control is similar to that in FIG. 17B.

In a case of a text, it is desirable that the text be not cut off even partly because the text has a meaning. Thus, as illustrated in FIGS. 16A and 17A, it is desirable to control the text box 406 not to overlap with the placement prohibited area 408 or not to protrude from the page. On the other hand, in the case of a stamp and a picture, there is a possibility that the user wants to put only part of them in the album. For example, there are a case in which a desired shape is expressed by only part of the stamp and a case in which a picture is placed by intentionally protruding from the page because an edge portion thereof is unnecessary. Thus, in the case of the stamp and the picture, it is desirable to place them along the movable area 413 as illustrated in FIGS. 17B and 18B even if part of the object protrudes from the page. In other words, in the present exemplary embodiment, in a case where the object cannot be pasted in the paste position specified by the user, it is desirable to change a reference of the placement possible area and to control a shift amount based on a type of object.

In the above-described exemplary embodiments, an image (picture), a text, and a stamp which are laid out have been described as examples of objects, but the present disclosure can also be implemented using other objects. For example, an image other than a picture may be used.

Further, in the above-described exemplary embodiments, a PC is described as an example of the information processing apparatus, and an operation by a pointing device such as a mouse is described as an example of the operation, but the present disclosure can also be implemented on a terminal device such as a smartphone or a tablet. In this case, an operation is performed with a finger or a pen. Then, a touched position corresponds to specification of the paste position.

### Other Embodiments

Embodiment(s) of the present disclosure can also be realized by a computer of a system or apparatus that reads out and executes computer executable instructions (e.g,, one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiments) and/or controlling the one or more circuits to perform the functions of one or more of the above-described embodiment(s). The computer may comprise one or more processors (e.g., central processing unit (CPU), micro processing unit (MPJ)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, a paste position can be appropriately controlled.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-169200, filed Oct. 6, 2020, which is hereby incorporated by reference herein in its entirety.

What is claimed is:

1. A control method executed by at least one processor in an information processing apparatus, the control method comprising:
storing an object placed on a first page spread in a memory area of the information processing apparatus based on a copy operation by a user;
performing paste processing for pasting the stored object on a second page spread different from the first page spread; and
performing determination processing for determining whether a paste candidate position of the object is in a placement possible area,
wherein, in the determination processing, a position in the second page spread corresponding to a position in which the object is placed in the first page spread is used as a paste candidate position, and whether the paste candidate position is in the placement possible area is determined, and
wherein, in the paste processing, in a case where the paste candidate position is determined as being in the placement possible area, the object is pasted in the paste candidate position, and in a case where the paste candidate position is determined as not being in the placement possible area, the object is pasted in a position different from the paste candidate position in the second page spread.

2. The control method according to claim 1, wherein, in the determination processing, a coordinate position in the second page spread corresponding to a coordinate position in which the object is placed in the first page spread is used as the paste candidate position.

3. The control method according to claim 1, wherein, in the case where the paste candidate position is determined as not being in the placement possible area in the determination processing, the object is pasted in a default placement position in the second page spread.

4. The control method according to claim 1, wherein, in the case where the paste candidate position is determined as not being in the placement possible area in the determination processing, the object is pasted in a position being a same position on either of a vertical axis and a horizontal axis as the paste candidate position in the second page spread.

5. The control method according to claim 1, wherein, in the determination processing, in a case where the paste candidate position is not included in a placement prohibited area provided in the second page spread, the paste candidate position is determined as being in the placement possible area, and in a case where the paste candidate position is included in the placement prohibited area, the paste candidate position is determined as not being in the placement possible area.

6. The control method according to claim 1, wherein, in the determination processing, in a case where the object to be placed in the paste candidate position does not protrude from the second page spread, the paste candidate position is determined as being in the placement possible area, and in a case where the object to be placed in the paste candidate position protrudes from the second page spread, the paste candidate position is determined as not being in the placement possible area.

7. The control method according to claim 1, wherein, in the determination processing, in a case where the object to be placed in the paste candidate position does not protrude from a movable area of the object, the paste candidate position is determined as being in the placement possible area, and in a case where the object to be placed in the paste candidate position protrudes from the movable area, the paste candidate position is determined as not being in the placement possible area.

8. The control method according to claim 1, wherein, in the determination processing, whether a paste position of the object is specified is further determined, and in a case where the paste position of the object is specified, the specified paste position is used as the paste candidate position, and whether the paste candidate position is in the placement possible area is determined.

9. The control method according to claim 1, wherein, in the determination processing, a type of object is further determined, and a reference of the placement possible area is changed based on the type of object.

10. An information processing apparatus comprising:
at least one processor causing the information processing apparatus to act as:
a storage unit configured to store an object placed on a first page spread in a memory area of the information processing apparatus based on a copy operation by a user;
a processing unit configured to perform paste processing for pasting the stored object on a second page spread different from the first page spread; and
a determination unit configured to perform determination processing for determining whether a paste candidate position of the object is in a placement possible area,
wherein the determination unit uses a position in the second page spread corresponding to a position in which the object is placed in the first page spread as a paste candidate position and determines whether the paste candidate position is in the placement possible area, and
wherein the processing unit pastes the object in the paste candidate position in a case where the paste candidate position is determined as being in the placement possible area and pastes the object in a position different from the paste candidate position in the second page spread in a case where the paste candidate position is determined as not being in the placement possible area.

11. The information processing apparatus according to claim 10, wherein, in the determination processing, a coordinate position in the second page spread corresponding to a coordinate position in which the object is placed in the first page spread is used as the paste candidate position.

12. The information processing apparatus according to claim 10, wherein, in the case where the paste candidate position is determined as not being in the placement possible area in the determination processing, the object is pasted in a default placement position in the second page spread.

13. The information processing apparatus according to claim 10, wherein, in the case where the paste candidate position is determined as not being in the placement possible area in the determination processing, the object is pasted in a position being a same position on either of a vertical axis and a horizontal axis as the paste candidate position in the second page spread.

14. The information processing apparatus according to claim 10, wherein, in the determination processing, in a case where the paste candidate position is not included in a placement prohibited area provided in the second page spread, the paste candidate position is determined as being in the placement possible area, and in a case where the paste candidate position is included in the placement prohibited area, the paste candidate position is determined as not being in the placement possible area.

15. The information processing apparatus according to claim 10, wherein, in the determination processing, in a case where the object to be placed in the paste candidate position does not protrude from the second page spread, the paste candidate position is determined as being in the placement possible area, and in a case where the object to be placed in the paste candidate position protrudes from the second page spread, the paste candidate position is determined as not being in the placement possible area.

16. The information processing apparatus according to claim 10, wherein, in the determination processing, in a case where the object to be placed in the paste candidate position does not protrude from a movable area of the object, the paste candidate position is determined as being in the placement possible area, and in a case where the object to be placed in the paste candidate position protrudes from the movable area, the paste candidate position is determined as not being in the placement possible area.

17. The information processing apparatus according to claim 10, wherein, in the determination processing, whether a paste position of the object is specified is further determined, and in a case where the paste position of the object is specified, the specified paste position is used as the paste candidate position, and whether the paste candidate position is in the placement possible area is determined.

18. The information processing apparatus according to claim 10, wherein, in the determination processing, a type of object is further determined, and a reference of the placement possible area is changed based on the type of object.
